(19) United States
(12) Patent Application Publication
(10) Pub. No.: US 2008/0014413 A1
(43) Pub. Date: Jan. 17, 2008

(54) THERMALLY EXPANDABLE SHEET, MOLDED PRODUCT FOR VEHICLE USING THE THERMALLY EXPANDABLE SHEET, AND METHOD FOR MANUFACTURING THE SHEET AND PRODUCT

(75) Inventors: Kazuo TANABE, Ogaki-shi (JP); Tetsuya NAKAMURA, Ichinomiya-shi (JP); Miwa FUSE, Aichi-gun (JP); Rintaro SENOO, Nagoya-shi (JP)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: TOYOTA BOSHOKU KABUSHIKI KAISHA, Kariya-shi (JP)

(21) Appl. No.: 11/774,946

(22) Filed: Jul. 9, 2007

(30) Foreign Application Priority Data
Jul. 11, 2006 (JP) P2006-190209

(51) Int. Cl. B32B 3/00; D02G 1/20

(52) U.S. Cl. 428/172; 264/103

(57) ABSTRACT

A thermally expandable sheet includes a nonwoven fabric layer and reinforcing material layers formed of inorganic fiber. The reinforcing material layers are formed on the surfaces of the nonwoven fabric layer. The thickness of each reinforcing material layer is less than the thickness of the nonwoven fabric layer. The nonwoven fabric layer and the reinforcing material layers are impregnated with thermally expandable microcapsules and resin. A molded product for vehicle is manufactured from the thermally expandable sheet and includes closed cells generated by expansion of the thermally expandable microcapsules in the nonwoven fabric layer.

### BACKGROUND OF THE INVENTION

The present invention relates to a thermally expandable sheet that contains thermally expandable microcapsules, which expand when being heated to a predetermined temperature, and that can be formed into a predetermined shape. The present invention also pertains to a molded product for vehicle using the thermally expandable sheet. Furthermore, the present invention pertains to a method for manufacturing the thermally expandable sheet and the molded product for vehicle.

A technique for manufacturing a molded ceiling, which is a type of a molded product for vehicle, has been proposed that uses, as a core material, a composite material formed by binding inorganic fibers by a diallyl phthalate resin composition or a material formed by adhering such a composite material to a surface of an organic resin expandable sheet or a surface of an organic fiber nonwoven fabric. Hereinafter, the above technique is referred to as a first prior art. For example, see Japanese Laid-Open Patent Publication No. 2004-50911.

Furthermore, a technique has been proposed that uses, as material for molded products for vehicle, a composite material obtained by after impregnating a web material with at least one of a diallyl phthalate resin and an unsaturated polyester resin, which contain thermally expandable microcapsules, laminating a porous body such as a honeycomb paper on the web material and then subjecting the web material to thermocompression molding. Hereinafter, the above technique is referred to as a second prior art. For example, see Japanese Laid-Open Patent Publication No. 2002-347198.

As demand for reduction in the fuel consumption and high performance of vehicles is increased, further weight reduction of molded products for vehicle is required. In the first prior art, in order to further reduce the weight of the molded ceiling, for example, the weight of the organic fiber nonwoven fabric per unit area may be reduced. However, in this case, as the result of reducing the thickness of the molded ceiling, the rigidity of the molded ceiling is reduced. This reduces the efficiency in assembling the molded ceiling.

In the second prior art, although the porous body increases the rigidity of the molded product for vehicle, the weight is undesirably increased. Thus, the usage of the porous body conflicts with the purpose of reducing the weight of the molded product for vehicle. Furthermore, the porous body such as a honeycomb paper does not accurately deform when bending and forming. Thus, the formability of the composite material of the second prior art is not sufficient as material for the molded product for vehicle such as the molded ceiling.

### SUMMARY OF THE INVENTION

Accordingly, it is an objective of the present invention to provide a light and highly rigid molded product for vehicle having sufficient formability, and a method for manufacturing the molded product. It is also an objective of the present invention to provide a thermally expandable sheet useful as material for such a molded product for vehicle, and a method for manufacturing the thermally expandable sheet.

To achieve the above objective, and in accorance with a first aspect of the present invention, a thermally expandable sheet, which includes a nonwoven fabric layer and a reinforcing material layer, is provided. The reinforcing material layer is formed of inorganic fiber. The reinforcing material layer is formed on a surface of the nonwoven fabric layer. The thickness of the reinforcing material layer is less than the thickness of the nonwoven fabric layer. The nonwoven fabric layer and the reinforcing material layer are both impregnated with thermally expandable microcapsules and resin.

With the thermally expandable sheet configured as described above, the nonwoven fabric layer is enlarged by expanding the thermally expandable microcapsules in the nonwoven fabric layer. Therefore, although the fiber weight of the nonwoven fabric layer per unit area is reduced to obtain a light molded product for vehicle, the molded product manufactured from the thermally expandable sheet has a thickness that ensures sufficient rigidity. Also, the molded product manufactured from the thermally expandable sheet is superior in maintaining its shape due to the function of the reinforcing material layer. Furthermore, since the thickness of the reinforcing material layer is less than the thickness of the nonwoven fabric layer, the molded product accurately deforms when bending and forming and has sufficient formability. Moreover, due to the function of the reinforcing material layer, the molded product is superior in maintaining its shape.

In the above-mentioned thermally expandable sheet, the fiber weight per unit area of the reinforcing material layer is preferably 50 to 135 g/m². If the fiber weight per unit area of the reinforcing material layer is less than 50 g/m², the rigidity and the shape retention of the molded product manufactured from the thermally expandable sheet might be insufficient. If the fiber weight per unit area of the reinforcing material layer exceeds 135 g/m², the rigidity of the thermally expandable sheet might become excessive, and the formability when bending and forming the molded product manufactured from the thermally expandable sheet might be reduced. In this respect, if the fiber weight per unit area of the reinforcing material layer is 50 to 135 g/m², such problems are suppressed.

In the above-mentioned thermally expandable sheet, the fiber weight per unit area of the nonwoven fabric layer is preferably 40 to 80 g/m². If the fiber weight per unit area of the nonwoven fabric layer is less than 40 g/m², the rigidity and the shape retention of the molded product manufactured from the thermally expandable sheet might be insufficient. If the fiber weight per unit area of the nonwoven fabric layer exceeds 80 g/m², the weight of the molded product manufactured from the thermally expandable sheet might not be sufficiently reduced. In this respect, if the fiber weight per unit area of the nonwoven fabric layer is 40 to 80 g/m², such problems are suppressed.

In the above-mentioned thermally expandable sheet, the resin impregnated in the nonwoven fabric layer and the reinforcing material layer may be a thermosetting resin having a curing temperature of 130 to 180° C. In this case, the thermally expandable microcapsules preferably have an expansion starting temperature of 120 to 180° C. With this configuration, by adjusting the expansion starting temperature of the thermally expandable microcapsules and the curing temperature of the thermosetting resin as required, enlargement of the nonwoven fabric layer caused by the expansion of the thermally expandable microcapsules in the nonwoven fabric layer and shape fixing of the molded product by heat curing of the thermosetting resin are simultaneously performed. This reduces the number of processes in manufacturing the molded product, and the molded product having excellent rigidity and shape retention is easily manufactured.

In the above-mentioned thermally expandable sheet, the reinforcing material layer may be one of reinforcing material layers formed on both sides of the nonwoven fabric layer. The weight of the thermally expandable microcapsules impregnated in an unit area of the nonwoven fabric layer is preferably 35 to 40 g/m² in terms of solid content. If the weight of the thermally expandable microcapsules impregnated in a unit area of the nonwoven fabric layer is less than 35 g/m² in terms of solid content, the thickness of the molded product manufactured from the thermally expandable sheet might be insufficient. As a result, for example, when using the molded product for a molded ceiling of a vehicle, the molded ceiling might bend during assembly due to insufficient rigidity. If the weight of the thermally expandable microcapsules impregnated in an unit area of the nonwoven fabric layer exceeds 40 g/m² in terms of solid content, although the weight of the molded product per unit volume is reduced, sufficient rigidity and shape retention might not be ensured. In this respect, if the weight of the thermally expandable microcapsules impregnated in an unit area of the nonwoven fabric layer is 35 to 40 g/m² in terms of solid content, such problems are suppressed.

In accordance with a second aspect of the present invention, a method for manufacturing a thermally expandable sheet is provided. The method includes: joining a nonwoven fabric layer and a reinforcing material layer formed of inorganic fiber to each other, the thickness of the reinforcing material layer being less than the thickness of the nonwoven fabric layer; and causing the nonwoven fabric layer and the reinforcing material layer, which are joined to each other, to contact a microcapsule-containing resin composition, which contains thermally expandable microcapsules and resin, thereby impregnating the nonwoven fabric layer and the reinforcing material layer with the thermally expandable microcapsules and the resin. According to this method, a thermally expandable sheet is obtained that is useful as material of molded products for vehicle that are light and highly rigid, and have sufficient formability.

The above-mentioned method may further include needle punching the nonwoven fabric layer and the reinforcing material layer, which are joined to each other, in the thickness direction of both layers prior to causing the nonwoven fabric layer and the reinforcing material layer to contact the microcapsule-containing resin composition. In this case, the constituent fibers of the nonwoven fabric layer and the constituent fibers of the reinforcing material layer intertwine with one another at the boundary between the nonwoven fabric layer and the reinforcing material layer, which increases the bond strength between the nonwoven fabric layer and the reinforcing material layer. Thus, the nonwoven fabric layer and the reinforcing material layer are prevented from being displaced from each other when contacting the microcapsule-containing resin composition. This increases the workability when manufacturing the thermally expandable sheet.

In accordance with a third aspect of the present invention, a molded product for vehicle manufactured from the above-mentioned thermally expandable sheet is provided. The molded product for vehicle includes, in the nonwoven fabric layer, closed cells generated by expansion of the thermally expandable microcapsules in the nonwoven fabric layer. With this configuration, air flow through the molded product for vehicle is suppressed. Therefore, quietness and cleanliness in a vehicle compartment are increased since the molded product for vehicle suppresses noise and unhealthy air from entering the vehicle compartment.

In accordance with a fourth aspect of the present invention, a method for manufacturing a molded product for vehicle from the above-mentioned thermally expandable sheet is provided. The method includes holding the thermally expandable sheet under an environment that exceeds an expansion starting temperature of the thermally expandable microcapsules, and thereby expanding the thermally expandable microcapsules in the thermally expandable sheet and enlarging the nonwoven fabric layer. According to this method, a light and highly rigid molded product for vehicle having sufficient formability is obtained.

In the above-mentioned method for manufacturing the molded product for vehicle, holding the thermally expandable sheet under an environment that exceeds an expansion starting temperature of the thermally expandable microcapsules may include arranging the thermally expandable sheet between a pair of molds the maximum distance between which at a cavity is greater than the thickness of the thermally expandable sheet when the molds are matched together, and enlarging the nonwoven fabric layer of the thermally expandable sheet in the molds by heating the thermally expandable sheet via the molds. In this case, the rigidity of the molded product for vehicle is increased without using a porous body, which is a separate member from the molded product for vehicle such as a honeycomb member. Furthermore, although the fiber weight of the nonwoven fabric layer per unit area is reduced to obtain a light molded product for vehicle, the enlargement of the nonwoven fabric layer prevents decrease in the rigidity of the molded product for vehicle.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram illustrating a manufacturing process of a thermally expandable sheet according to one embodiment of the present invention;

FIG. 2 is a partial cross-sectional view illustrating a thermally expandable sheet obtained through the manufacturing process of FIG. 1;

FIG. 3 is a cross-sectional view illustrating a manner in which a molded product is thermally molded from the thermally expandable sheet of FIG. 2 using a thermoform mold; and

FIG. 4 is a partial cross-sectional view illustrating a molded ceiling manufactured from the thermally expandable sheet of FIG. 2.

### DETAILED DESCRIPTION OF THE PREFERRED EMBODIMENTS

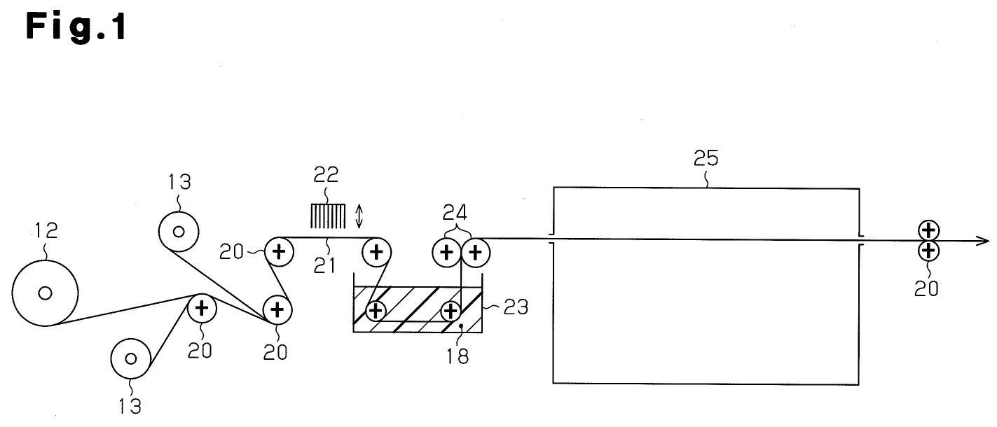

One embodiment of the present invention will now be described with reference to FIGS. 1 to 4.

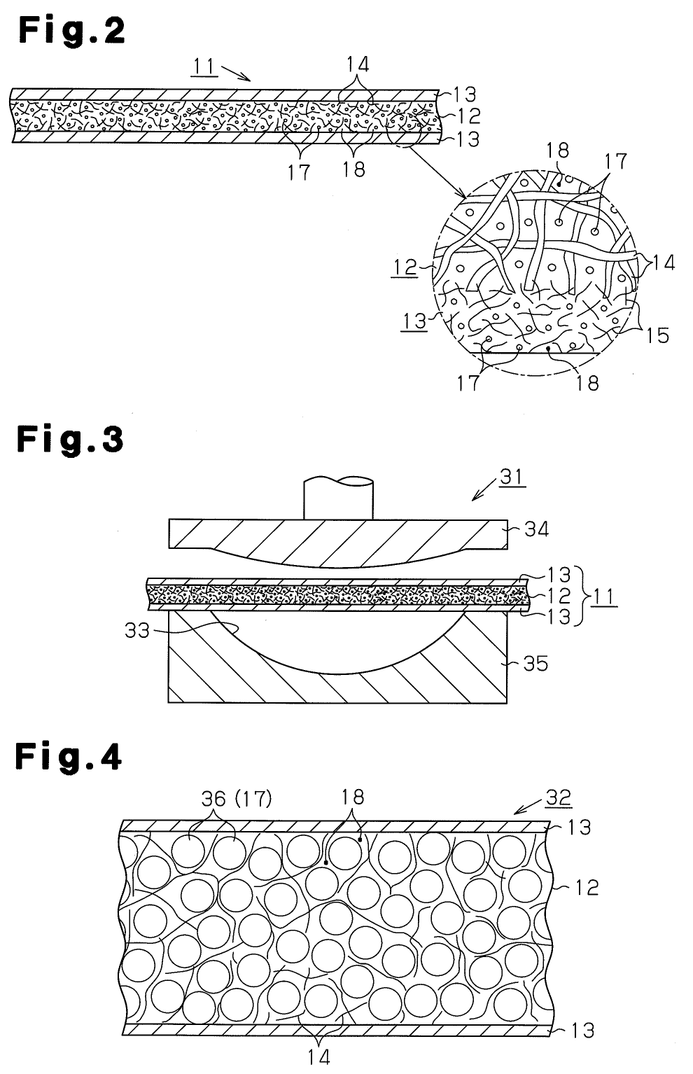

As shown in FIG. 2, a thermally expandable sheet 11 of the preferred embodiment includes a nonwoven fabric layer 12 and reinforcing material layers 13, which are formed on both sides of the nonwoven fabric layer 12. The thickness of each reinforcing material layer 13 is less than the thickness of the nonwoven fabric layer 12. The nonwoven fabric layer 12 is configured by a great number of constituent fibers 14, and the reinforcing material layers 13 are configured by a great number of constituent fibers 15. A microcapsule-containing resin composition is impregnated in gaps between the constituent fibers 14 of the nonwoven fabric layer 12 and gaps between the constituent fibers 15 of the reinforcing material layers 13. The microcapsule-containing resin composition contains at least a thermosetting resin 18 and thermally expandable microcapsules 17, which are dispersed in the thermosetting resin 18 and expand when being heated to a predetermined temperature.

The constituent fibers 14 of the nonwoven fabric layer 12 may be, for example, synthetic fiber such as polyester fiber, polypropylene fiber, and polyamide fiber, natural fiber such as cotton fiber and cellulose fiber, or regenerated fiber such as rayon fiber. Among these, the polyester fiber is suitable from the aspect of economical efficiency and versatility. The nonwoven fabric layer 12 may be formed by, but not limited to, for example, a nonwoven fabric such as a needlepunched nonwoven fabric, a spunbonded nonwoven fabric, a thermally bonded nonwoven fabric, and a chemically bonded nonwoven fabric. Among these, the needlepunched nonwoven fabric is preferable. In a case where the nonwoven fabric layer 12 is formed by the needlepunched nonwoven fabric, since the fiber orientation of the needlepunched nonwoven fabric is random, the nonwoven fabric layer 12 tends to enlarge in its thickness direction when the thermally expandable microcapsules 17 in the nonwoven fabric layer 12 expand. The fiber weight per unit area of the nonwoven fabric layer 12 is desirably 40 to 80 g/m².

The constituent fibers 15 of the reinforcing material layers 13 are, for example, inorganic fiber such as glass fiber, carbon fiber, ceramic fiber, and rock wool fiber. The preferable reinforcing material layer 13 from the aspect of economical efficiency and workability is formed of a glass fiber chopped strand mat. In a case where the reinforcing material layers 13 are formed by an inorganic fiber mat, since most of the fibers in the inorganic fiber mat are oriented in a direction perpendicular to the thickness direction of the mat, when the thermally expandable microcapsules 17 in the reinforcing material layers 13 expand, the thermosetting resin 18 in the reinforcing material layers 13 is extruded toward the nonwoven fabric layer 12 instead of the reinforcing material layers 13 enlarging in the thickness direction. The fiber weight per unit area of the reinforcing material layers 13 is desirably 50 to 135 g/m².

The thermosetting resin 18 may be, for example, a diallyl phthalate resin, an unsaturated polyester resin, or a mixture thereof. The diallyl phthalate resin is generally used in the form of a prepolymer having allyl unsaturated bond at its side chain obtained by partially polymerizing diallyl phthalate. The unsaturated polyester resin is obtained by reacting an unsaturated polybasic acid or a mixture of the unsaturated polybasic acid and a saturated polybasic acid with polyalcohol in conventional manners. The unsaturated polybasic acid may be, for example, fumaric acid or maleic anhydride. The saturated polybasic acid may be, for example, phthalic anhydride, isophthalic acid, terephthalic acid, tetrahydrophthalic anhydride, methyltetrahydrophthalic anhydride, endomethylene tetrahydrophthalic anhydride, adipic acid, sebacic acid, HET acid, or tetrabromophthalic anhydride. The polyalcohol may be, for example, ethylene glycol, propylene glycol, diethylene glycol, dipropylene glycol, neopentyl glycol, 1,3-butylene glycol, 1,4-butylene glycol, 1,6-hexane diol, bisphenol hydride A, adduct of bisphenol A with propylene glycol, or a mixture thereof.

The microcapsule-containing resin composition generally includes a polymerization initiator. The microcapsule-containing resin composition may further contain at least one of a polymerization inhibitor, a polymerization accelerator, an internal mold release agent, a filler, and a coloring agent as required. The polymerization initiator may be, for example, an organic peroxide such as dicumyl peroxide, benzoyl peroxide, lauroyl peroxide, and t-butyl perbenzoate, or an azo compound such as azobisisobutyronitrile.

The thermosetting resin 18 desirably has a curing temperature of 130 to 180° C. The curing temperature of a diallyl phthalate resin is 130 to 160° C.

The thermally expandable microcapsules 17 are configured by a shell and an expanding agent that fills the shell. The shell is formed of, but not limited to, for example, a homopolymer or a copolymer of acrylonitrile, vinyl chloride, vinylidene chloride, acrylic ester, methacrylic ester, styrene, and vinyl acetate. The expanding agent may be, for example, a hydrocarbon such as propane, butane, pentane, hexane, and structural isomers thereof, an organic solvent such as petroleum ether, or a carbonate or a hydrogen carbonate such as sodium hydrogen carbonate that generates carbon dioxide gas by thermal decomposition or a chemical reaction. The thermally expandable microcapsules 17 desirably have an expansion starting temperature of 120 to 180° C. The weight ratio of the thermally expandable microcapsules 17 to the thermosetting resin 18 in the microcapsule-containing resin composition is desirably 1.0/1.2 to 1.0/2.0. The weight of the thermally expandable microcapsules 17 impregnated in an unit area of the nonwoven fabric layer 12 is desirably 35 to 40 g/m² in terms of solid content.

The microcapsule-containing resin composition is used in the form of emulsion or suspension. In the microcapsule-containing resin composition, an organic solvent may be used as a medium. However, it is required that the organic solvent be able to dissolve the thermosetting resin 18 and do not destroy the shells of the thermally expandable microcapsules 17 by dissolving and swelling. For example, when the thermosetting resin 18 is a diallyl phthalate resin or an unsaturated polyester resin, an aromatic hydrocarbon such as toluene and xylene or a mixed solvent formed by mixing the aromatic hydrocarbon in an alcoholic solvent other than methanol is used in a suitable manner.

A method for manufacturing the thermally expandable sheet 11 will now be described with reference to FIG. 1.

As shown in FIG. 1, one roll of the nonwoven fabric sheet 12 and two rolls of the reinforcing material sheets 13 are prepared. The nonwoven fabric sheet 12 and the reinforcing material sheets 13 are then fed using rolls 20 such that the reinforcing material sheets 13 are joined to both sides of the nonwoven fabric sheet 12. In this manner, a laminated body 21 having three layers is formed. Instead of joining the reinforcing material sheets 13 on both sides of the nonwoven fabric sheet 12, one reinforcing material sheet 13 may be joined to only one side of the nonwoven fabric sheet 12. In this case, the obtained laminated body 21 has two layers.

Subsequently, the laminated body 21 is needlepunched along the thickness direction of the laminated body 21. That is, the laminated body 21 is repeatedly penetrated by using needles 22 that move along the thickness direction of the laminated body 21. The needlepunching causes the constituent fibers 14 of the nonwoven fabric layer 12 to be intertwined with the constituent fibers 15 of the reinforcing material layers 13 at the boundaries between the nonwoven fabric layer 12 and the reinforcing material layers 13 as shown in FIG. 2. Thus, the bond strength between the nonwoven fabric layer 12 and the reinforcing material layers 13 is increased. The needlepunching may also be omitted.

The laminated body 21 that has been needlepunched is then immersed in an immersion tank 23, which contains the microcapsule-containing resin composition, and is passed through the immersion tank 23. As a result, the nonwoven fabric layer 12 and the reinforcing material layers 13 of the laminated body 21 are impregnated with the microcapsule-containing resin composition. The impregnation of the microcapsule-containing resin composition is not necessarily performed by immersion, but may be performed by, for example, coating using a metering knife, a roll coater, a comma coater, or a squeegee.

The laminated body 21 that has been impregnated with the microcapsule-containing resin composition is passed between a pair of squeeze rolls 24 to squeeze excessive microcapsule-containing resin composition out of the laminated body 21. Thereafter, the laminated body 21 is passed through a drying furnace 25 to remove a solvent and a dispersion medium in the microcapsule-containing resin composition. The laminated body 21 needs to be dried under a temperature at which the thermally expandable microcapsules 17 in the laminated body 21 do not expand and the thermosetting resin 18 in the laminated body 21 does not cure. The laminated body 21 that is sent out of the drying furnace 25, that is, the thermally expandable sheet 11 is rolled up.

A method for manufacturing a molded ceiling 32 having a predetermined curved surface from the thermally expandable sheet 11 using a thermoform mold 31 will now be described with reference to FIGS. 3 and 4.

As shown in FIG. 3, the thermally expandable sheet 11 is arranged between an upper mold 34 and a lower mold 35 of the thermoform mold 31, which has a cavity 33 of a predetermined shape. The maximum distance between the upper and lower molds 34, 35 at the cavity 33 when the upper mold 34 and the lower mold 35 are matched together is greater than the thickness of the thermally expandable sheet 11, and is preferably approximately eight to ten times the thickness of the thermally expandable sheet 11. After matching the upper mold 34 and the lower mold 35 together, the upper mold 34 and the lower mold 35 are heated to expand the thermally expandable microcapsules 17 in the thermally expandable sheet 11 and to cure the thermosetting resin 18 in the thermally expandable sheet 11. The expansion of the thermally expandable microcapsules 17 and the curing of the thermosetting resin 18 are completed by heating for a predetermined time period.

In the molded ceiling 32 obtained in this manner, closed cells, that is, microballoons 36 are formed in the nonwoven fabric layer 12 by the expansion of the thermally expandable microcapsules 17 in the nonwoven fabric layer 12 as shown in FIG. 4. The cured thermosetting resin 18 serves as a wall for defining cavities of the microballoons 36. The thermosetting resin 18 in the reinforcing material layers 13 is extruded from the reinforcing material layers 13 and are moved inside the nonwoven fabric layer 12 by the expansion of the thermally expandable microcapsules 17 in the reinforcing material layers 13. In FIG. 4, to facilitate understanding, the size of the microballoons 36 is exaggerated.

### EXAMPLE

Chopped strand mats (manufactured by Nippon Electric Glass Co., Ltd.) formed of glass fiber having a fiber weight per unit area of 100 g/m² were joined on both sides of a needlepunched nonwoven fabric (manufactured by Kureha Ltd.) formed of polyester fiber having a fiber weight per unit area of 60 g/m² to form a laminated body having three layers. After needlepunching the laminated body, the laminated body was immersed in a microcapsule-containing resin composition, which contains thermally expandable microcapsules (manufactured by Expancel) and a diallyl phthalate resin composition (manufactured by FUJI POLYMER CO., LTD.), in an immersion tank. With regard to the immersed laminated body, the weight of the microcapsule-containing resin composition impregnated in an unit area of the laminated body was 90 g/m² in terms of solid content. The weight ratio of the thermally expandable microcapsules to the diallyl phthalate resin in the microcapsule-containing resin composition that was used was 40/50. The laminated body impregnated with the microcapsule-containing resin composition in this manner was passed through a drying furnace the temperature of which was maintained at 100 to 120° C. to obtain the thermally expandable sheet having a thickness of 0.8 mm.

Then, to manufacture a molded ceiling from the thermally expandable sheet, the thermally expandable sheet was arranged in a thermoform mold. More specifically, the thermally expandable sheet was arranged between demolded upper and lower molds of the thermoform mold. The maximum distance between the upper mold and the lower mold at a cavity was set to 5.0 mm when the upper mold and the lower mold were matched together. By heating the thermoform mold to 150° C. and maintaining at the same temperature for one minute, the molded ceiling having a predetermined shape was obtained. The obtained molded ceiling was light while having a sufficient thickness and rigidity. Furthermore, the shape of the molded ceiling accurately reflected the curved surface of the cavity of the thermoform mold. Moreover, the light and highly rigid molded ceiling was easily obtained without performing a burdensome procedure of adhering the nonwoven fabric layer with the reinforcing material layers after expansion of the thermally expandable microcapsules.

The preferred embodiment may be modified as follows.

In the above embodiment, the thermally expandable sheet 11 is formed into a predetermined shape while being heated in the thermoform mold 31 to obtain the molded ceiling 32. However, for example, the thermally expandable sheet 11 may be passed through a heating furnace to expand the thermally expandable microcapsules 17 in the thermally expandable sheet 11 so that the nonwoven fabric layer 12 of the thermally expandable sheet 11 is enlarged in its thickness direction. Thereafter, a cold forming may be performed using a mold or a pressure roller to obtain the molded ceiling 32 having a predetermined shape.

After completion of the expansion of the thermally expandable microcapsules 17 in the thermally expandable sheet 11, the thermosetting resin 18 in the thermally expandable sheet 11 may be cured. In this case, the curing temperature of the thermosetting resin 18 needs to be higher than the expansion starting temperature of the thermally expandable microcapsules 17.

In the above embodiment, the microcapsule-containing resin composition may contain at least the thermally expandable microcapsules 17 and the thermoplastic resin, instead of containing at least the thermally expandable microcapsules 17 and the thermosetting resin 18. In this case, the melting point of the thermoplastic resin to be used needs to be lower than the melting point of the constituent fibers 14 of the nonwoven fabric layer 12.

Instead of the molded ceiling 32, for example, other molded product for vehicle such as a door trim and a floor material may be formed from the thermally expandable sheet 11.

1. A thermally expandable sheet comprising:
a nonwoven fabric layer; and
a reinforcing material layer formed of inorganic fiber, the reinforcing material layer being formed on a surface of the nonwoven fabric layer, the thickness of the reinforcing material layer being less than the thickness of the nonwoven fabric layer,
wherein the nonwoven fabric layer and the reinforcing material layer are both impregnated with thermally expandable microcapsules and resin.

2. The thermally expandable sheet according to claim 1, wherein the fiber weight per unit area of the reinforcing material layer is 50 to 135 g/m².

3. The thermally expandable sheet according to claim 1, wherein the fiber weight per unit area of the nonwoven fabric layer is 40 to 80 g/m².

4. The thermally expandable sheet according to claim 1, wherein the resin impregnated in the nonwoven fabric layer and the reinforcing material layer is a thermosetting resin having a curing temperature of 130 to 180° C., and the thermally expandable microcapsules have an expansion starting temperature of 120 to 180° C.

5. The thermally expandable sheet according to claim 1, wherein the reinforcing material layer is one of reinforcing material layers formed on both sides of the nonwoven fabric layer, and the weight of the thermally expandable microcapsules impregnated in an unit area of the nonwoven fabric layer is 35 to 40 g/m² in terms of solid content.

6. A method for manufacturing a thermally expandable sheet, the method comprising:
joining a nonwoven fabric layer and a reinforcing material layer formed of inorganic fiber to each other, the thickness of the reinforcing material layer being less than the thickness of the nonwoven fabric layer; and
causing the nonwoven fabric layer and the reinforcing material layer, which are joined to each other, to contact a microcapsule-containing resin composition, which contains thermally expandable microcapsules and resin, thereby impregnating the nonwoven fabric layer and the reinforcing material layer with the thermally expandable microcapsules and the resin.

7. The method according to claim 6, further comprising needle punching the nonwoven fabric layer and the reinforcing material layer, which are joined to each other, in the thickness direction of both layers prior to causing the nonwoven fabric layer and the reinforcing material layer to contact the microcapsule-containing resin composition.

8. A molded product for vehicle manufactured from a thermally expandable sheet, the thermally expandable sheet includes:
a nonwoven fabric layer; and
a reinforcing material layer formed of inorganic fiber, the reinforcing material layer being formed on a surface of the nonwoven fabric layer, the thickness of the reinforcing material layer being less than the thickness of the nonwoven fabric layer,
wherein the nonwoven fabric layer and the reinforcing material layer are both impregnated with thermally expandable microcapsules and resin, the molded product for vehicle comprising, in the nonwoven fabric layer, closed cells generated by expansion of the thermally expandable microcapsules in the nonwoven fabric layer.

9. A method for manufacturing a molded product for vehicle from a thermally expandable sheet, the thermally expandable sheet includes:
a nonwoven fabric layer; and
a reinforcing material layer formed of inorganic fiber, the reinforcing material layer being formed on a surface of the nonwoven fabric layer, the thickness of the reinforcing material layer being less than the thickness of the nonwoven fabric layer,
wherein the nonwoven fabric layer and the reinforcing material layer are both impregnated with thermally expandable microcapsules and resin, the method comprising holding the thermally expandable sheet under an environment that exceeds an expansion starting temperature of the thermally expandable microcapsules, thereby expanding the thermally expandable microcapsules in the thermally expandable sheet and enlarging the nonwoven fabric layer.

10. The method according to claim 9, wherein holding the thermally expandable sheet under an environment that exceeds the expansion starting temperature of the thermally expandable microcapsules includes arranging the thermally expandable sheet between a pair of molds the maximum distance between which at a cavity is greater than the thickness of the thermally expandable sheet when the molds are matched together, and enlarging the nonwoven fabric layer of the thermally expandable sheet in the molds by heating the thermally expandable sheet via the molds.
